(19) United States
(12) Patent Application Publication
(10) Pub. No.: US 2015/0052280 A1
(43) Pub. Date: Feb. 19, 2015

(54) METHOD AND SYSTEM FOR COMMUNICATIONS-STACK OFFLOAD TO A HARDWARE CONTROLLER

(71) Applicant: Emulex Design & Manufactring Corporation, Costa Mesa, CA (US)

(72) Inventor: David Craig Lawson, Richardson, TX (US)

(73) Assignee: Emulex Design & Manufacturing Corporation, Costa Mesa, CA (US)

(21) Appl. No.: 13/969,975

(22) Filed: Aug. 19, 2013

(51) Int. Cl. G06F 13/28

(52) U.S. Cl. CPC G06F 13/28
USPC 710/308

(57) ABSTRACT

The current document is directed to offloading communications processing from server computers to hardware controllers, including network interface controllers. In one implementation, the transport channel and zero, one, or more protocol channels immediately overlying the transport channel of a Windows Communication Foundation communications stack are offloaded to a network interface controller. The offloading of communications processing carried out by the methods and systems to which the current document is directed involves minimal supporting development and is configurable, during service-application initialization, by exchange of relatively small amounts of information between an enhanced NIC and the communications stack.

### CLAIM OF PRIORITY

Not applicable

### INCORPORATION BY REFERENCE

Not applicable

### TECHNICAL FIELD

The current document is directed to communications processing for computer networking and, in particular, to a method and system for offloading communications processing from server computers to hardware controllers, including network interface controllers.

### BACKGROUND

Early computer systems generally included a single processor and a small set of relatively unintelligent peripheral components, including magnetic disks, teletype machines, tape drives, and other such peripheral components. Early processors were large, relatively low speed, expensive, and consumed large amounts of power relative to their instruction-execution bandwidths. Over the next 50 years, processors continuously evolved into the extremely fast, small, and relatively inexpensive processors found in today's personal computers, server computers, and mobile electronic devices, as well as in a plethora of modern processor-controlled consumer devices, including the control components of automobiles, digital cameras, and various home appliances. As the hardware components of computer systems have evolved, so have the software components of computer systems, which now routinely handle complex distributed-computing and parallel-processing tasks that could not have been addressed in early computational systems. As a result, the number of types of, capabilities of, and capacities of peripheral devices have greatly expanded and increased, made possible by inclusion of fast, low-cost processors and intelligent software-control components that facilitate cooperation between system processors and peripheral-component processors. As a result of this evolution of peripheral devices, more and more of the computational overhead associated with tasks performed by computer systems has shifted to the processors within peripheral devices and to specialized processors included within computer systems, including specialized graphics processors that facilitate the rendering of data for display by computer display devices and monitors.

One example of the trend towards offloading computational overhead to peripheral devices is referred to as the “TCP-offload-engine” (“TOE”) technology included in various different network interface controllers (“NICs”). The TOE technology essentially offloads the processing of the entire transmission control protocol (“TCP”)/internet protocol (“IP”) communications stack from the system processor to one or more processors included within a NIC. The intent of the TOE technology is to free up system processor cycles by moving TCP/IP processing to the NIC. Because of the extremely fast rate of data transmission through TCP/IP-implemented local and wide-area networks, a significant fraction of system processing cycles may end up expended for networking within computer systems that do not use NICs that incorporate TOE technology. However, TOE technology has not been widely adopted and used, for a variety of reasons. First, TOE implementations are generally propriety and hardware-vendor specific. As a result, significant additional operating-system development and development and/or modification of other types of software control components are generally needed to incorporate TOE devices into computer systems. Furthermore, this additional development is continuous and ongoing, since computer systems and NICs continue to quickly evolve. Another reason for the lack of widespread adoption of the TOE technology is that, in many cases, the TOE technology violates basic assumptions made by operating-system-kernel developers with regard to the division of control of a computer system between the operating system kernel and other computer-system components. For these and many other reasons, including a variety of security considerations, TOE technology represents somewhat of a technological dead end in the current computing environment. However, despite this particular outcome, designers, manufacturers, vendors, and users of computer systems nonetheless continue to seek methods and systems that facilitate offload of computational overhead from busy system processors to peripheral-device processors and specialized processors within computer systems. Further limitations and disadvantages of conventional and traditional approaches will become apparent to one of skill in the art, through comparison of such approaches with some aspects of the present method and system set forth in the remainder of this disclosure with reference to the drawings.

### BRIEF SUMMARY

The current document is directed to offloading communications processing from server computers to hardware controllers, including network interface controllers. In one implementation, the transport channel and zero, one, or more protocol channels immediately overlying the transport channel of a Windows Communication Foundation communications stack are offloaded to a network interface controller. The offloading of communications processing carried out by the methods and systems to which the current document is directed involves minimal supporting development and is configurable, during service-application initialization, by exchange of relatively small amounts of information between an enhanced NIC and the communications stack.

### BRIEF DESCRIPTION OF THE DRAWINGS

FIG. 1 provides a general architectural diagram for various types of computers.

FIG. 2 illustrates a network interface controller (“NIC”).

FIG. 3A illustrates generalized hardware and software components of a general-purpose computer system, such as a general-purpose computer system having an architecture similar to that shown in FIG. 1.

FIG. 3B illustrates one type of virtual machine and virtual-machine execution environment.

FIG. 4 illustrates electronic communications between a client and server computer.

FIG. 5 illustrates the Windows Communication Foundation (“WCF”) model for network communications used to interconnect consumers of services with service-providing applications running within server computers.

FIG. 6 illustrates offload of a portion of the computational overhead of a WCF communications stack into an enhanced NIC according to the methods and systems disclosed in the current document.

FIG. 7 illustrates offload of a portion of a communications stack below a service application in a server computer in which the service application runs within an execution environment provided by a guest operating system that, in turn, runs above a virtualization layer.

FIGS. 8A-9B illustrate a method for providing a relatively direct communication path between user-mode code within a server computer and an enhanced NIC device.

FIGS. 10A-B provide more detail with regard to the custom offload channel and OS-bypass mechanism used in certain implementations of server computer systems that include enhanced NIC devices with offload capabilities.

FIGS. 11A-B illustrate XML-based specifications of an entry point and a service contract.

FIG. 12A illustrates, using a somewhat different illustration convention than used in previous figures, the WCF communications stack associated with web services along with the standards supported within the communications stack.

FIGS. 12B-C provide tables that further describe the WCF communications stack.

FIG. 13 provides a table of the various different standard bindings supported by WCF.

FIGS. 14A-B illustrate XML-based binding configurations.

FIG. 15 illustrates use of a binding configuration inquiry NIC command by a custom protocol channel.

FIGS. 16A-B illustrate examples of communications-stack configuration based on a stack signature returned by an enhanced NIC.

FIGS. 17A-B provide control-flow diagrams that illustrate the implementation of communications-stack offload to an enhanced NIC in the user-mode portion of a server communications stack.

FIGS. 18A-C illustrate operation of an enhanced NIC with offload capability.

### DETAILED DESCRIPTION

Unlike the above-discussed TOE technologies, the current document is directed to a flexible method and system for offloading computational overhead associated with computer networking from system processors to network interface controllers (“NICs”) using standardized interfaces. The methods and systems to which the current document is directed allow for offload of network processing to enhanced NICs without the need for extensive control-component modification and development. Furthermore, the presently disclosed methods and systems are extensible and readily modifiable.

It should be noted, at the onset, that the methods and systems to which the current document is directed are physical components of computer systems and other processor-controlled systems that include various control components implemented as computer instructions encoded within physical data-storage devices, including electronic memories, mass-storage devices, optical disks, and other such physical data-storage devices and media. As those familiar with computer science and various engineering fields will understand, the control components of modern systems, implemented as stored computer instructions for controlling operation of processor and processor-controlled devices and systems, are every bit as physical as the processors themselves, power supplies, magnetic-disk platters, and other such physical components of modern systems.

It should also be noted, at the onset, that the methods and systems to which the current document is directed are discussed and illustrated, in the current document, with reference to certain particular implementations. However, as with all complex modern methods and systems, there are many possible alternative implementations.

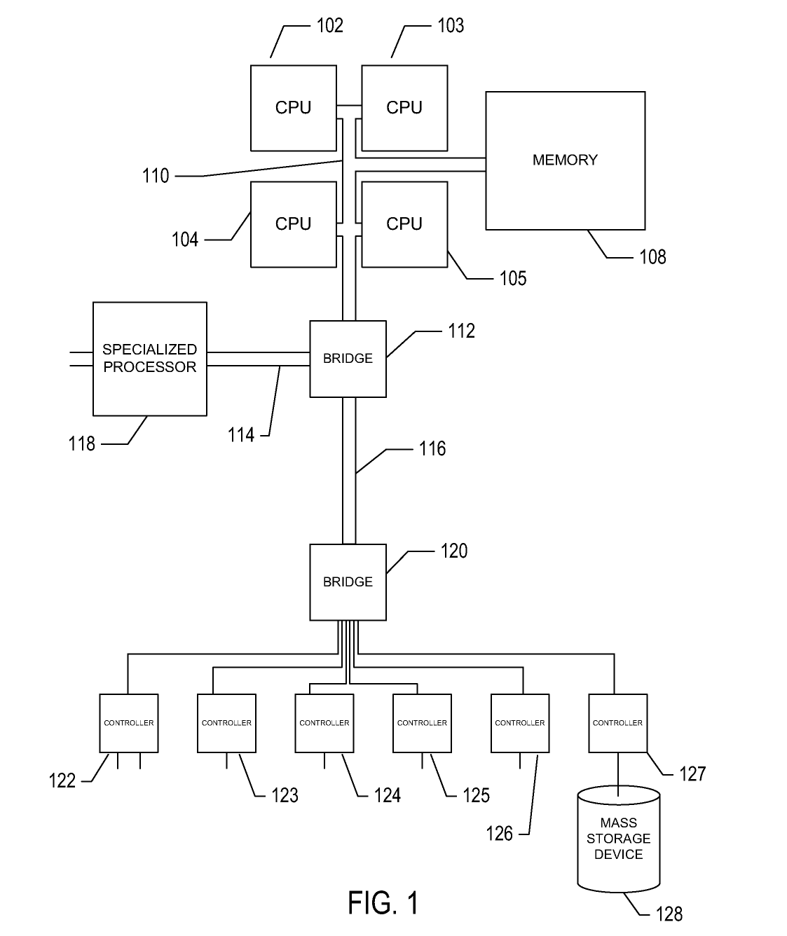

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources.

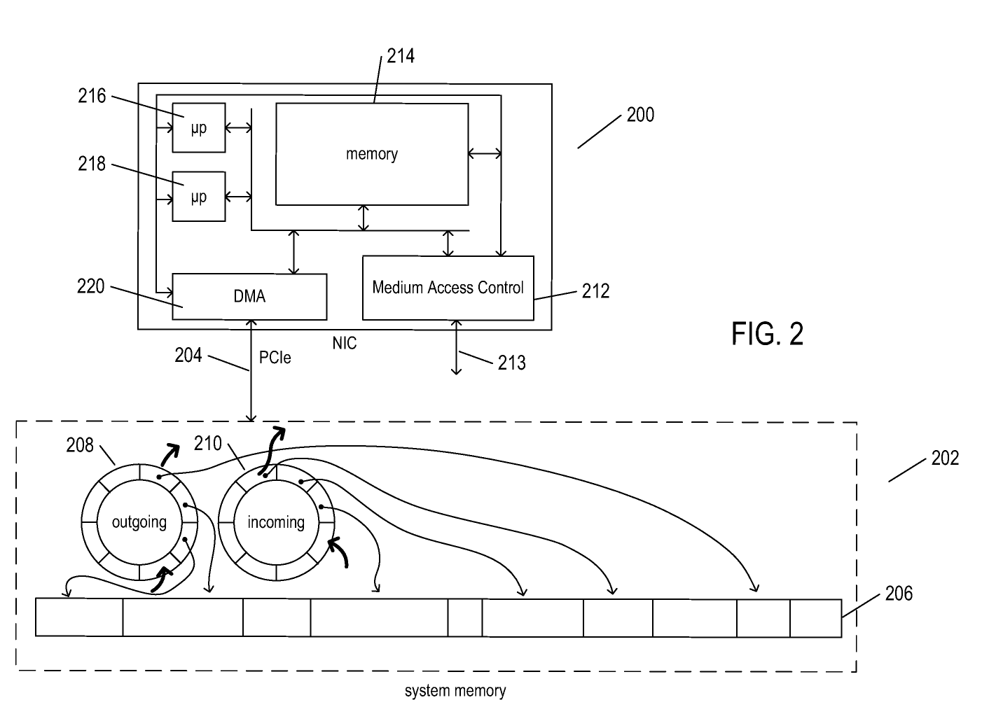

FIG. 2 illustrates a network interface controller (“NIC”). The NIC 200 is a peripheral device or controller that, in certain computer systems, is interconnected with system memory 202 via a PCIe communications medium 204 or another type of internal bus, serial link, or another type of communications medium. A portion of system memory may be allocated for incoming and outgoing messages or packets 206 and other portions of system memory may be allocated for an outgoing 208 and incoming 210 circular queue containing pointers, or references, to particular messages prepared by the system for transmission by the NIC or stored by the NIC for processing by the system. The NIC generally includes a medium access control (“MAC”) component 212 that interfaces with a communications medium 213, such as an optical fiber or Ethernet cable, various types of internal memory 214, one or more processors 216 and 218, and a direct-memory-access component (“DMA”) 220. The NIC is also interconnected with one or more system processors for exchange of control signals between the microprocessors of the NIC and system processors. Often, these control signals are asynchronous interrupts that allow the NIC to notify the processor when incoming messages have been stored by the NIC in system memory and allow the processor to signal the NIC when outgoing messages are available for transmission within system memory. Other types of control signals provide for initialization of the NIC and for other control operations. The exchange of interrupts may be carried out via the PCIe or other such internal communications media or through dedicated signal lines.

In general, a NIC is designed to carry out the computational tasks associated with the first two layers of the open systems interconnection (“OSI”) computer communications model, namely the physical layer and the data-link layer. In the case of the above-described TOE technology, the NIC also carries out layers 3-5 of the OSI model. However, as also discussed above, the TOE technology has not been widely accepted and used. During steady-state operation, the NIC can be viewed as a hardware/firmware peripheral device that transmits messages to, and receives messages from, a physical communications medium. The transmitted messages are read via the DMA component of the NIC from system memory and the received messages are written to system memory by the DMA component. The microprocessors and various types of memory within the NIC store and execute firmware instructions, respectively, for carrying out these tasks.

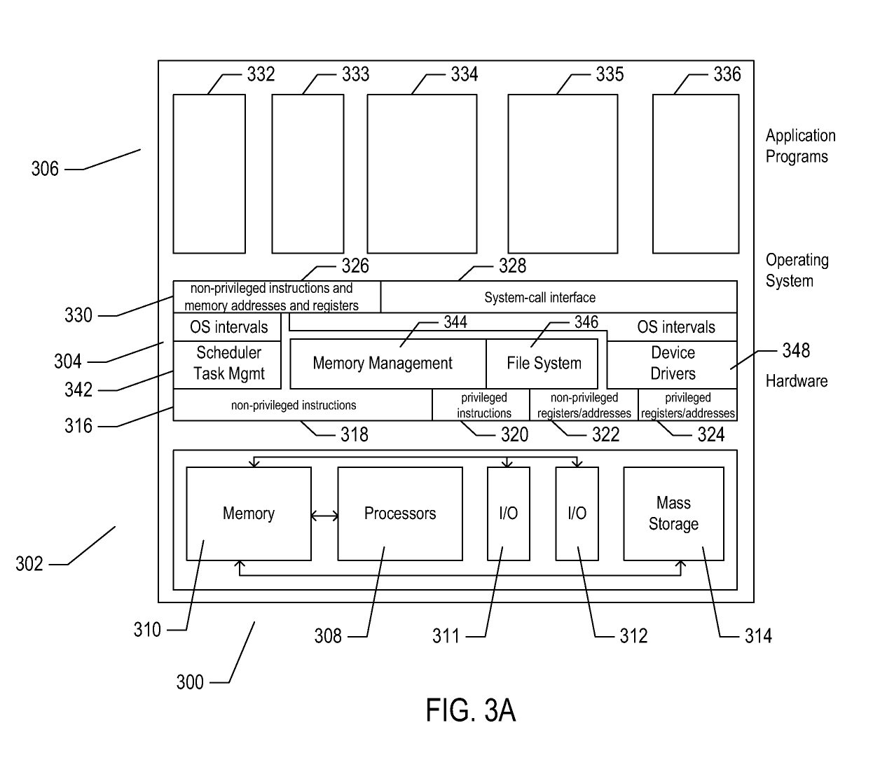

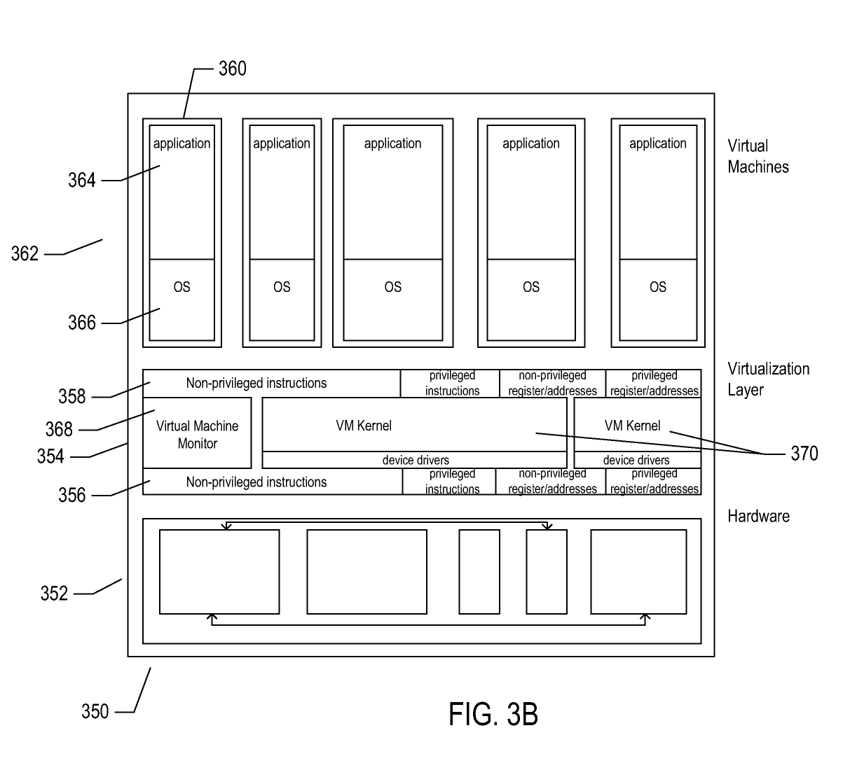

FIG. 3A illustrates generalized hardware and software components of a general-purpose computer system, such as a general-purpose computer system having an architecture similar to that shown in FIG. 1. The computer system 300 is often considered to include three fundamental layers: (1) a hardware layer or level 302; (2) an operating-system layer or level 304; and (3) an application-program layer or level 306. The hardware layer 302 includes one or more processors 308, system memory 310, various different types of input-output (“I/O”) devices 311 and 312, and mass-storage devices 314. Of course, the hardware level also includes many other components, including power supplies, internal communications links and busses, specialized integrated circuits, many different types of processor-controlled or microprocessor-controlled peripheral devices and controllers, and many other components. The operating system 304 interfaces to the hardware level 302 through a low-level operating system and hardware interface 316 generally comprising a set of non-privileged computer instructions 318, a set of privileged computer instructions 320, a set of non-privileged registers and memory addresses 322, and a set of privileged registers and memory addresses 324. In general, the operating system exposes non-privileged instructions, non-privileged registers, and non-privileged memory addresses 326 and a system-call interface 328 as an operating-system interface 330 to application programs 332-336 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 342, memory management 344, a file system 346, device drivers 348, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 336 facilitates abstraction of mass-storage-device and memory resources as a high-level, easy-to-access, file-system interface.

For many reasons, a higher level of abstraction, referred to as the “virtual machine,” has been developed and evolved to further abstract computer hardware in order to address many difficulties and challenges associated with traditional computing systems, including the compatibility issues discussed above. FIG. 3B illustrates one type of virtual machine and virtual-machine execution environment. FIG. 3B uses the same illustration conventions as used in FIG. 3A. In particular, the computer system 350 in FIG. 3B includes the same hardware layer 352 as the hardware layer 302 shown in FIG. 3A. However, rather than providing an operating system layer directly above the hardware layer, as in FIG. 3A, the virtualized computing environment illustrated in FIG. 3B features a virtualization layer 354 that interfaces through a virtualization-layer/hardware-layer interface 356, equivalent to interface 316 in FIG. 3A, to the hardware. The virtualization layer provides a hardware-like interface 358 to a number of virtual machines, such as virtual machine 360, executing above the virtualization layer in a virtual-machine layer 362. Each virtual machine includes one or more application programs or other higher-level computational entities packaged together with an operating system, such as application 364 and operating system 366 packaged together within virtual machine 360. Each virtual machine is thus equivalent to the operating-system layer 304 and application-program layer 306 in the general-purpose computer system shown in FIG. 3A. Each operating system within a virtual machine interfaces to the virtualization-layer interface 358 rather than to the actual hardware interface 356. The virtualization layer partitions hardware resources into abstract virtual-hardware layers to which each operating system within a virtual machine interfaces. The operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 358 may differ for different operating systems. For example, the virtualization layer is generally able to provide virtual hardware interfaces for a variety of different types of computer hardware. This allows, as one example, a virtual machine that includes an operating system designed for a particular computer architecture to run on hardware of a different architecture. The number of virtual machines need not be equal to the number of physical processors or even a multiple of the number of processors. The virtualization layer includes a virtual-machine-monitor module 368 that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the operating system within a virtual machine accesses virtual privileged instructions, virtual privileged registers, and virtual privileged memory through the virtualization-layer interface 358, the accesses result in execution of virtualization-layer code to simulate or emulate the privileged resources. The virtualization layer additionally includes a kernel module 370 that manages memory, communications, and data-storage machine resources on behalf of executing virtual machines. The kernel, for example, maintains shadow page tables on each virtual machine so that hardware-level virtual-memory facilities can be used to process memory accesses. The kernel additionally includes routines that implement virtual communications and data-storage devices as well as device drivers that directly control the operation of underlying hardware communications and data-storage devices. Similarly, the kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

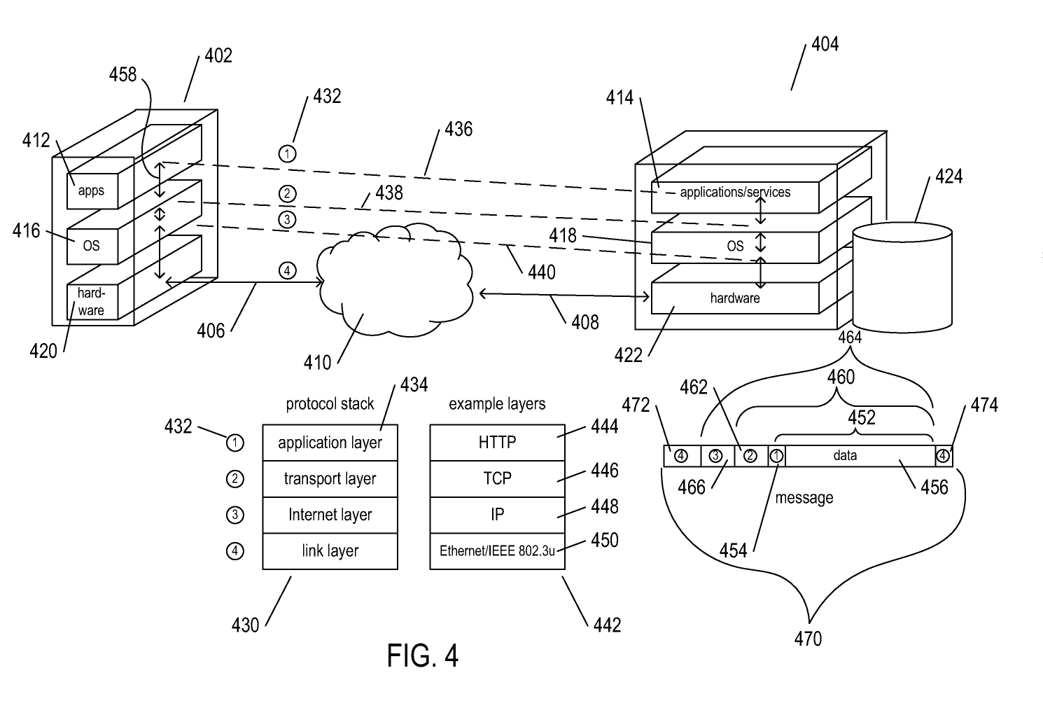

FIG. 4 illustrates electronic communications between a client and server computer. The following discussion of FIG. 4 provides an overview of electronic communications. This is, however, a very large and complex subject area, a full discussion of which would likely run for many hundreds or thousands of pages. The following overview is provided as a basis for discussing communications stacks, with reference to subsequent figures. In FIG. 4, a client computer 402 is shown to be interconnected with a server computer 404 via local communication links 406 and 408 and a complex distributed intermediary communications system 410, such as the Internet. This complex communications system may include a large number of individual computer systems and many types of electronic communications media, including wide-area networks, public switched telephone networks, wireless communications, satellite communications, and many other types of electronics-communications systems and intermediate computer systems, routers, bridges, and other device and system components. Both the server and client computers are shown to include three basic internal layers including an applications layer 412 in the client computer and a corresponding applications and services layer 414 in the server computer, an operating-system layer 416 and 418, and a hardware layer 420 and 422. The server computer 404 is additionally associated with an internal, peripheral, or remote data-storage subsystem 424. The hardware layers 420 and 422 may include the components discussed above with reference to FIG. 1 as well as many additional hardware components and subsystems, such as power supplies, cooling fans, switches, auxiliary processors, and many other mechanical, electrical, electromechanical, and electro-optical-mechanical components. The operating system 416 and 418 represents the general control system of both a client computer 402 and a server computer 404. The operating system interfaces to the hardware layer through a set of registers that, under processor control, are used for transferring data, including commands and stored information, between the operating system and various hardware components. The operating system also provides a complex execution environment in which various application programs, including database management systems, web browsers, web services, and other application programs execute. In many cases, modern computer systems employ an additional layer between the operating system and the hardware layer, referred to as a “virtualization layer,” that interacts directly with the hardware and provides a virtual-hardware-execution environment for one or more operating systems.

Client systems may include any of many types of processor-controlled devices, including tablet computers, laptop computers, mobile smart phones, and other such processor-controlled devices. These various types of clients may include only a subset of the components included in a desktop personal component as well components not generally included in desktop personal computers.

Electronic communications between computer systems generally comprises packets of information, referred to as datagrams, transferred from client computers to server computers and from server computers to client computers. In many cases, the communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” In FIG. 4, a representation of a common protocol stack 430 is shown below the interconnected server and client computers 404 and 402. The layers are associated with layer numbers, such as layer number “1” 432 associated with the application layer 434. These same layer numbers are used in the depiction of the interconnection of the client computer 402 with the server computer 404, such as layer number “1” 432 associated with a horizontal dashed line 436 that represents interconnection of the application layer 412 of the client computer with the applications/services layer 414 of the server computer through an application-layer protocol. A dashed line 436 represents interconnection via the application-layer protocol in FIG. 4, because this interconnection is logical, rather than physical. Dashed-line 438 represents the logical interconnection of the operating-system layers of the client and server computers via a transport layer. Dashed line 440 represents the logical interconnection of the operating systems of the two computer systems via an Internet-layer protocol. Finally, links 406 and 408 and cloud 410 together represent the physical communications media and components that physically transfer data from the client computer to the server computer and from the server computer to the client computer. These physical communications components and media transfer data according to a link-layer protocol. In FIG. 4, a second table 442 is aligned with the table 430 that illustrates the protocol stack includes example protocols that may be used for each of the different protocol layers. The hypertext transfer protocol (“HTTP”) may be used as the application-layer protocol 444, the transmission control protocol (“TCP”) 446 may be used as the transport-layer protocol, the Internet protocol 448 (“IP”) may be used as the Internet-layer protocol, and, in the case of a computer system interconnected through a local Ethernet to the Internet, the Ethernet/IEEE 802.3u protocol 450 may be used for transmitting and receiving information from the computer system to the complex communications components of the Internet. Within cloud 410, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams, such as datagram 452. The datagram may generally include a header 454 as well as the data 456, encoded as a sequence of bytes within a block of memory. The header 454 is generally a record composed of multiple byte-encoded fields. The call by the application program to an application-layer system call is represented in FIG. 4 by solid vertical arrow 458. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 460 includes a transport-layer-message header 462 and an application-layer datagram 452. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally concerned with error control, segmentation, as discussed above, flow control, congestion control, application addressing, and other aspects of reliable end-to-end message transfer. The transport-layer datagrams are then forwarded to the Internet layer via system calls within the operating system and are embedded within Internet-layer datagrams 464, each including an Internet-layer header 466 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a NIC, which embeds the Internet-layer datagram 464 into a link-layer datagram 470 that includes a link-layer header 472 and generally includes a number of additional bytes 474 appended to the end of the Internet-layer datagram. The link-layer header includes collision-control and error-control information as well as local-network addresses. The link-layer packet or datagram 470 is a sequence of bytes that includes information introduced by each of the layers of the protocol stack as well as the actual data that is transferred from the source computer to the destination computer according to the application-layer protocol.

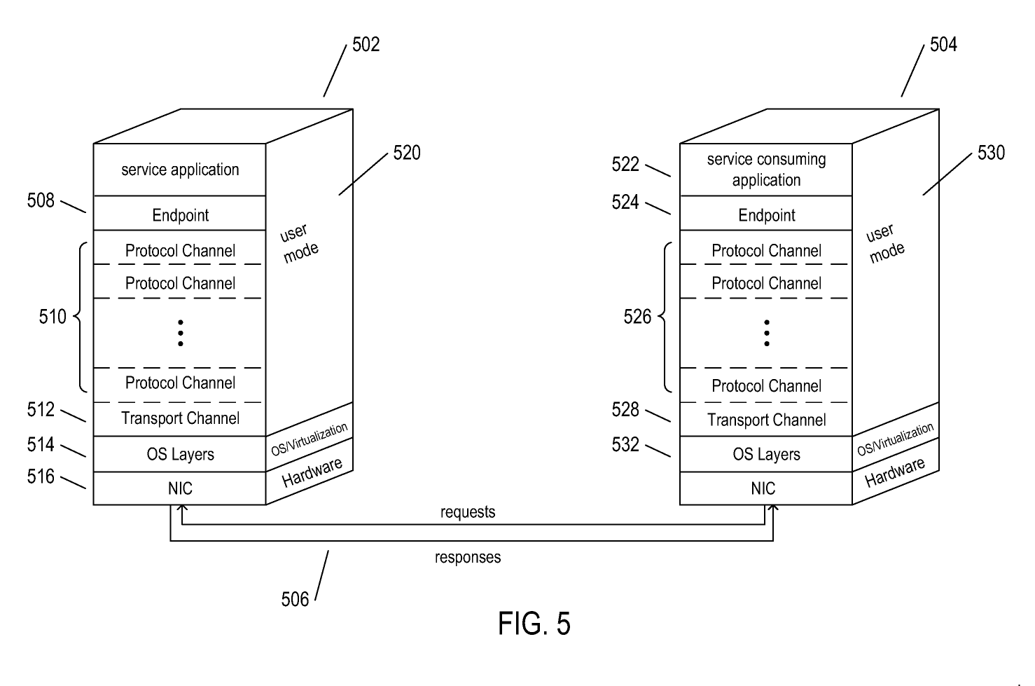

FIG. 5 illustrates the Windows Communication Foundation (“WCF”) model for network communications used to interconnect consumers of services with service-providing applications running within server computers. In FIG. 5, a server computer 502 is shown to be interconnected with a service-consuming application running on a user computer 504 via communications stacks of the WCF that exchange data through a physical communications medium or media 506. As shown in FIG. 5, the communications are based on the client/server model in which the service-consuming application transmits requests to the service application running on the service computer and the service application transmits responses to those requests back to the service-consuming application. The communications stack on the server computer includes an endpoint 508, a number of protocol channels 510, a transport channel 512, various lower-level layers implemented in an operating system or both in an operating system and a virtualization layer 514, and the hardware NIC peripheral device 516. Similar layers reside within the user computer 504. As also indicated in FIG. 5, the endpoint, protocol channels, and transport channel all execute in user mode, along with the service application 520 within the server computer 502 and, on the user computer, the service-consuming application 522, endpoint 524, protocol channels 526, and transport channel 528 also execute in user mode 530. The OS layers 514 and 532 execute either in an operating system or in a guest operating system and underlying virtualization layer.

An endpoint (508 and 524) encapsulates the information and logic needed by a service application to receive requests from service consumers and respond to those requests, on the server side, and encapsulate the information and logic needed by a client to transmit requests to a remote service application and receive responses to those requests. Endpoints can be defined either programmatically or in Extensible Markup Language (“XML”) configuration files. An endpoint logically consists of an address represented by an endpoint address class containing a universal resource identifier (“URI”) property and an authentication property, a service contract, and a binding that specifies the identities and orders of various protocol channels and the transport channel within the communications stack underlying the endpoint and overlying the various lower, operating-system layers or guest-operating-system layers and the NIC hardware. The contract specifies a set of operations or methods supported by the endpoint. The data type of each parameter or return value in the methods associated with an endpoint are associated with a data-contract attribute that specifies how the data type is serialized and deserialized. Each protocol channel represents one or more protocols applied to a message or packet to achieve one of various different types of goals, including security of data within the message, reliability of message transmission and delivery, message formatting, and other such goals. The transport channel is concerned with transmission of data streams or datagrams through remote computers, and may include error detection and correction, flow control, congestion control, and other such aspects of data transmission. Well-known transport protocols include the hypertext transport protocol (“HTTP”), the transmission control protocol (“TCP”), the user datagram protocol (“UDP”), and the simple network management protocol (“SNMP”). In general, lower-level communications tasks, including Internet-protocol addressing and routing, are carried out within the operating-system- or operating-system-and-virtualization layers 514 and 532.

The WCF model for network communications is part of the Microsoft.NET framework. The protocol channels and transport channel are together referred to as the binding, and each protocol channel and transport channel is referred to as an element of the binding. The WCF protocol stack has become a standard for client/server communications and offers many advantages to developers of server-based services. Bindings can be easily configured using XML configuration files to contain those elements desired by the developer of a service. In addition, developers can write custom protocol channels and transport channels that provide different or enhanced types of networking facilities. WCF also supports distribution of metadata that allows clients to obtain, from a server endpoint, sufficient information to allow the client to communicate with a server application via the endpoint.

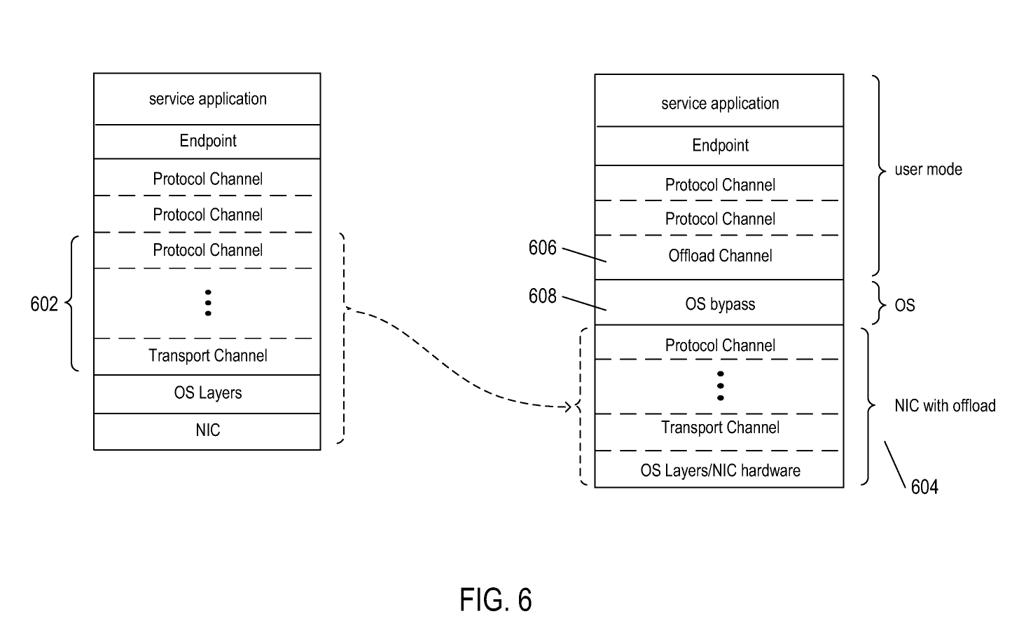

FIG. 6 illustrates offload of a portion of the computational overhead of a WCF communications stack into an enhanced NIC according to the methods and systems disclosed in the current document. As shown in FIG. 6, a number of protocol channels and the transport channel sequentially ordered within the binding 602 are moved from user-mode execution within the system processors of a server to an enhanced NIC that features offload capability 604. The offloaded transport channel and protocol channels are replaced, in the user-mode communications stack, with a custom offload channel 606 and an OS or kernel bypass mechanism 608. The enhanced NIC 604 also carries out the lower-level communications tasks that, in a traditional server, are carried out by the operating system or by a combination of a guest operating system and virtualization layer. It may be the case that only the transport layer is offloaded, rather than both the transport layer and one or more protocol channels.

One motivation for offloading a portion of the communications stack from user-mode execution by server processors to an enhanced NIC is to increase the available computational bandwidth of the server processors. In server computers used to host service applications, a significant portion of the overall computational bandwidth of the main server processors may be consumed by execution of networking-related computation. The more computation that can be carried out in an enhanced NIC, the more additional bandwidth available for execution of the service application and other higher-level tasks. Furthermore, when a server system includes multiple enhanced NICs, offloading of the communications stack to the multiple enhanced NICs represents a relatively easily implemented type of distributed, parallel processing that can significantly increase the information-transfer capacity of the server computer system.

Another feature of the methods and systems to which the current document is directed is that the enhanced NIC with offload capability can be quite flexible with regard to the portion of the communications stack offloaded from a server computer. In the example shown in FIG. 6, all but two of the protocol channels are offloaded to the enhanced NIC. In certain cases, only the transport channel may be offloadable while, in other cases, the entire binding may be offloadable, depending on which protocol channels and transport channels are supported by the enhanced NIC. Unlike previous TOE-technology NICs, the enhanced NICs to which the current document is directed can accommodate offloading of a variety of different bindings used by a variety of different endpoints configured for different service applications. Furthermore, the offloaded protocol channels and transport channels are standard elements of bindings, in many cases, rather than proprietary and vendor-specific partial communications-stack implementations. As a result, offload of portions of a WCF communications stack can be accomplished by very slight modifications to configuration files and protocol channels and transport channels. In certain cases, only a single custom offload protocol channel and kernel-bypass code are needed in addition to modification of the binding configuration within the configuration associated with an endpoint. In other implementations, relatively slight modifications of standard protocol channels may also be used to increase flexibility of offload.

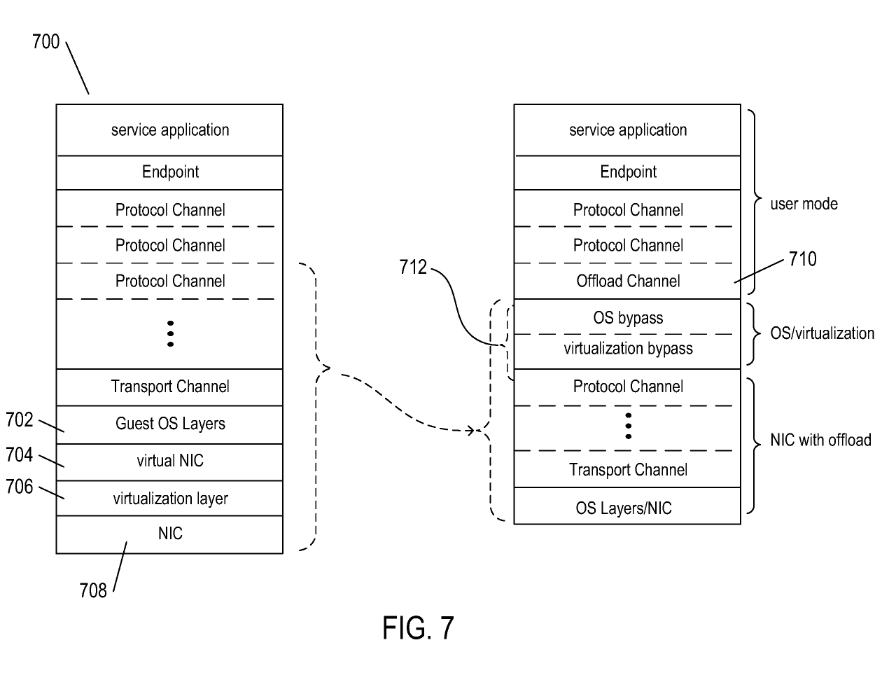

FIG. 7 illustrates offload of a portion of a communications stack below a service application in a server computer in which the service application runs within an execution environment provided by a guest operating system that, in turn, runs above a virtualization layer. In a commonly available server featuring a virtualization layer 700, the lower-level OS layers of the communications stack are executed by the guest operating system 702 which interfaces to a virtual NIC device 704 provided by a virtualization layer 706. The virtualization layer translates guest OS interaction with the virtual NIC to control inputs to an actual hardware NIC 708. In this case, offloading is accomplished by substituting a custom offload protocol channel 710 for a sequence of no, one, or more protocol channels and a transport channel and introduction of a combined OS/virtualization-layer bypass mechanism 712. The OS bypass layer 608 in FIG. 6 and the OS/virtualization bypass mechanism 712 in FIG. 7 both allow the user-mode offload channel to interact, with minimal operating system and virtualization layer support, with the enhanced NIC.

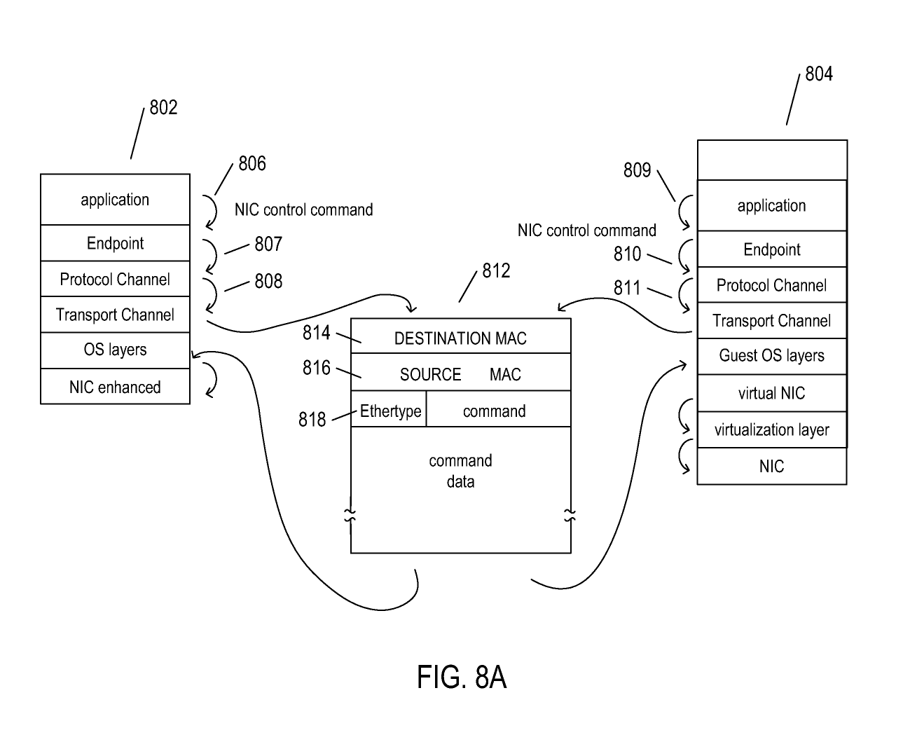

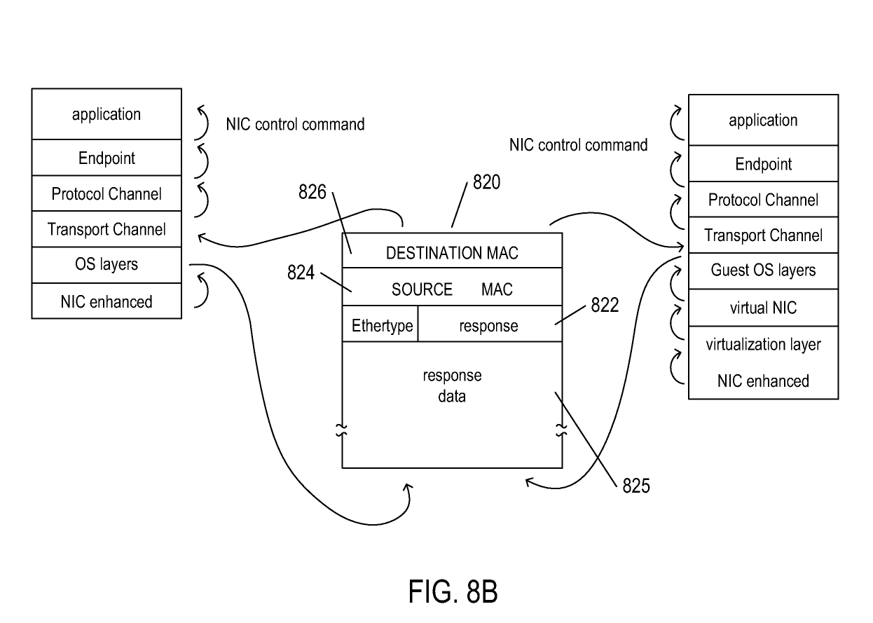

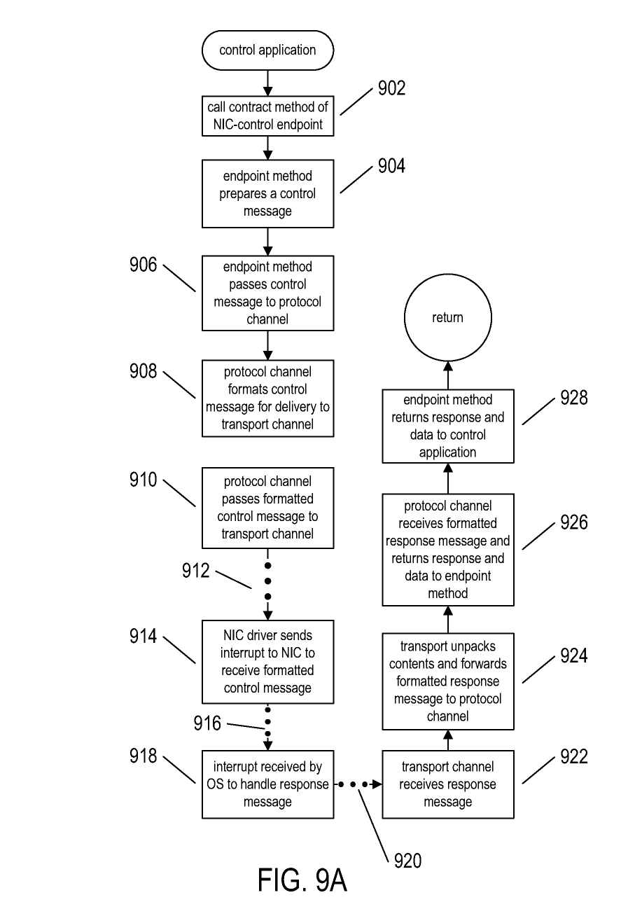

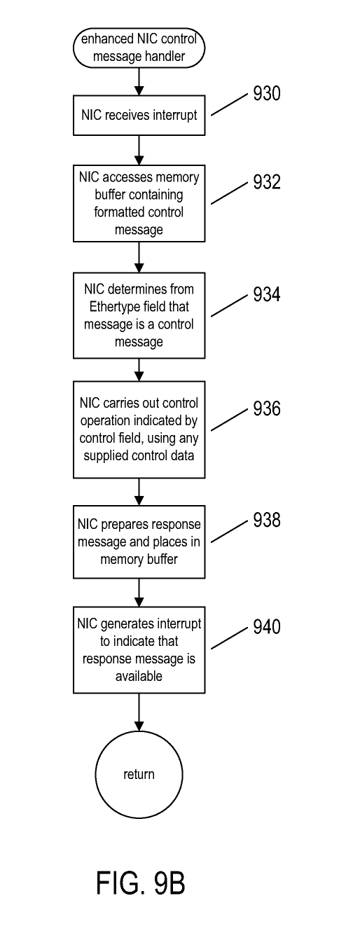

In certain implementations, a mechanism is used to allow a user-mode application to communicate relatively directly with an enhanced NIC, prior to establishment of an offload path from user-mode executables to the enhanced NIC. FIGS. 8A-9B illustrate a method for providing a relatively direct communication path between user-mode code within a server computer and an enhanced NIC device. As shown in FIG. 8A, the mechanism for user-mode to NIC communication can be carried out both in a non-virtualized server 802 as well as in a server that features a virtualization layer 804. In both cases, an application program calls a method associated with an endpoint for transferring NIC control commands to the NIC device. The NIC control commands generally include a command identifier encoded as an integer within a sequence of bytes and optionally includes additional command data. The endpoint packages the command and command data as the data for a message to be transmitted by the NIC to a remote device and then passes the command and command data down through the communications stack, as indicated by curved arrows 806-808 and 809-811. Eventually, within the transport channel, a formatted message is prepared that encapsulates the command and command data within a packet or message 812 that includes a destination-address field 814, a source-address field 816, and an Ethertype field 818. A special Ethertype value is inserted into the Ethertype field to indicate that the message is a NIC control command. The destination address 814 may be the MAC address of the local NIC and the source address field may contain an address associated with the endpoint. The message is passed, by the transport channel, to the lower levels of the communications stack by the normal method and is eventually provided, in a memory buffer, to the NIC along with an interrupt or other signal to notify the NIC that a message has been queued for handling by the NIC. The enhanced NIC recognizes the Ethertype value as corresponding to a NIC control command and therefore, rather than attempting to transmit the message to a remote computer, extracts the command and command data and carries out the requested command. Then, as shown in FIG. 8B, the NIC returns a response message 820 corresponding to the received command message 812 back up the communications stack to the application program. The response message may contain an encoded response type within a response-type field 822 and may optionally include response data 824. The MAC address of the NIC may be used for the source-address field 824 and an address associated with the endpoint may be used as the destination-address-field value 826.

FIG. 9A provides a control-flow diagram for the application side of the above-discus sed method for direct communications between user-mode executables and an enhanced NIC. In step 902, an application program calls a contract method of a NIC-control endpoint, passing to the method the command and optionally passing command data associated with the command. The endpoint method prepares a control message in step 904 which includes, or is associated with, a special Ethertype corresponding to NIC-control messages. In step 906, the endpoint method passes the control message to a first protocol channel which, in step 908, formats the control message for delivery to a transport channel. In step 910, the protocol channel passes the formatted control message to the transport channel. After a series of OS-layer operations, represented in FIG. 9A by dashed arrow 912, the operating system or a virtualization-layer kernel sends an interrupt to the enhanced NIC to indicate that the formatted control message has been placed in memory for handling by the NIC, in step 914. The NIC carries out the requested command, prepares a response message, and places the response message in a system-memory buffer in a series of steps represented by dotted arrow 916. Then, in step 918, the OS or virtualization-layer kernel receives an interrupt from the NIC device indicating that a message is available in system memory. The lower levels of message processing are carried out by the OS or a combination of a guest OS virtualization layer, as indicated by dotted arrow 920 in FIG. 9A, which eventually results in the transport channel receiving the response message in step 922. The transport channel unpacks the contents of the message and forwards a formatted response to the protocol channel, in step 924. The protocol channel receives the formatted response message and returns a response and the associated response data to the endpoint method in step 926. Finally, the endpoint method returns the response and any associated response data to the application in step 928.

FIG. 9B shows the enhanced NIC operations associated with processing of control messages discussed above with reference to FIGS. 8A-9A. In step 930, the NIC receives an interrupt indicating that a message is available in a memory buffer for the NIC to process. In step 932, the NIC accesses the memory buffer containing a formatted control message, determines that the Ethertype field of the message indicates the message to be a control message in step 934, and carries out the control operation indicated by the control field, using any supplied control data in step 936. In step 938, the NIC prepares a response message and places the response message in a system memory buffer. Finally, in step 940, the NIC generates an interrupt to a system processor to indicate that a response message is available in system memory.

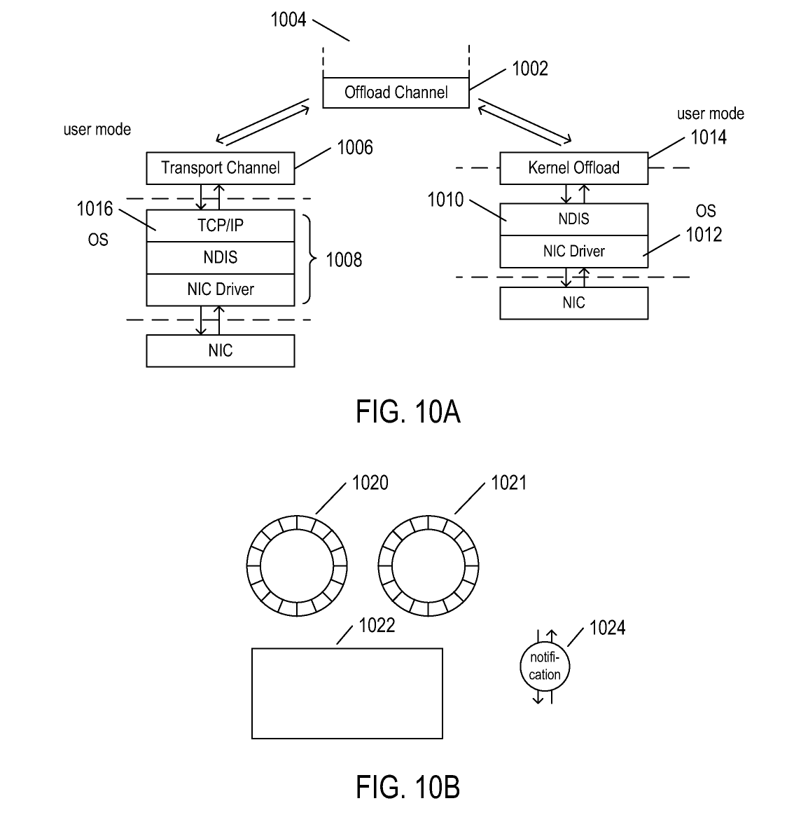

FIGS. 10A-B provide more detail with regard to the custom offload channel and OS-bypass mechanism used in certain implementations of server computer systems that include enhanced NIC devices with offload capabilities. In FIG. 10A, the custom offload channel 1002 is shown as the lowest-level channel in a server WCF communications stack 1004. The offload channel can either forward messages received from higher-level protocol channels to the customary transport channel 1006 for normal processing and forwarding to the standard OS layers 1008 or, when offload is available and initialized for the particular binding of which the offload channel is an element, the offload channel can instead use a bypass mechanism to forward the message directly to a network driver interface specification (“NDIS”) interface 1010 to an operating system or virtualization-layer-kernel NIC driver 1012. The offload channel 1002, in the latter scenario, interfaces to a kernel offload mechanism 1014 for transferring messages to the NIC without the messages being processed by the TCP/IP or equivalent lower-level processing 1016 within an operating system or the combination of a guest operating system and virtualization layer.

As shown in FIG. 10B, the kernel offload mechanism (1014 in FIG. 10A) generally involves shared-memory structures 1020-1022 for passing messages to, and receiving messages from, the enhanced NIC device as well as some type of mutual notification mechanism 1024 by which the offload channel can notify the kernel offload mechanism to direct a message stored in the shared memory structures to the NIC and by which the kernel offload mechanism can notify the offload channel of a received message in the shared memory buffer ready for processing by the offload channel and upper-level protocol channels. The particular implementation of the kernel bypass mechanism depends on the particular operating system or guest operating system and virtualization layer. In certain cases, as one example, the kernel bypass mechanism may employ direct user mode access to a control ring of the NIC hardware, in which case the kernel bypass mechanism would act as an alternative NIC driver to which user-mode code directly interfaces. In other implementations, the kernel bypass mechanism acts more as a special operating-system- or virtualization-layer entry point that circumvents the lower layers of a traditional communications stack normally executed within an operating system and/or virtualization kernel.

In the case that only the transport layer is offloaded, the offload mechanism may involve TCP-socket-level redirection, rather than the more complex offload mechanism discussed above with reference to FIGS. 10A-B. In this case, the offload mechanism may redirect the output of the lowest-level protocol channel to a different TCP socket, implemented within the NIC, by changing either the address family or a protocol number.

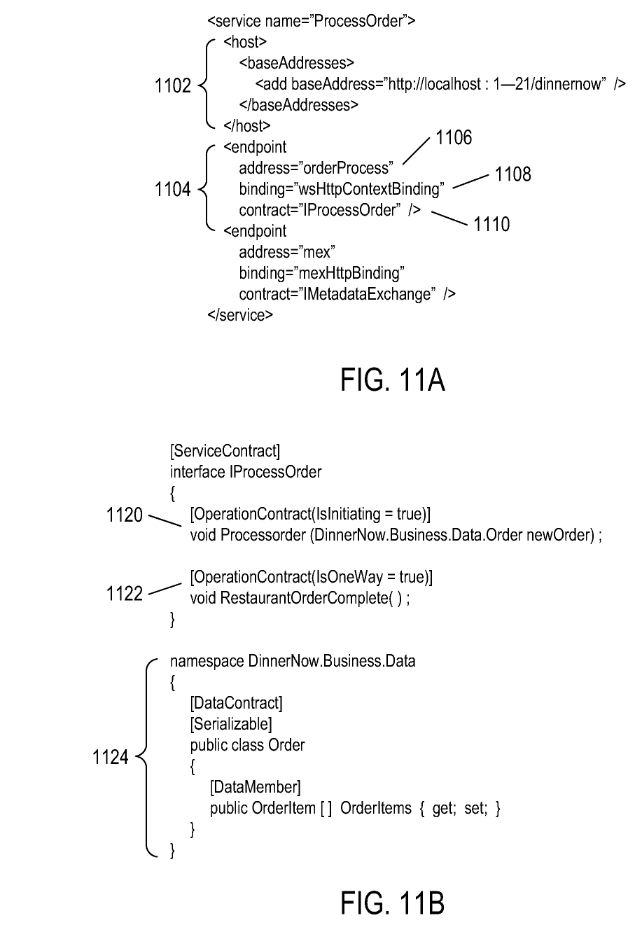

FIGS. 11A-B illustrate XML-based specifications of an entry point and a service contract. These examples are taken from an Internet article describing a particular use case for the WCF and .NET framework. FIG. 11A shows the XML-based specification for a Windows service which includes a description of the host server address 1102 and the endpoint 1104 associated with the service, the endpoint including a relative endpoint address 1106, a standard binding 1108, and a contract 1110. FIG. 11B shows an XML-based specification of the contract “IProcessOrder” associated with the Windows server “ProcessOrder” specified in FIG. 11A. The service contract includes two methods 1120 and 1122 and a data contract for the order data type 1124.

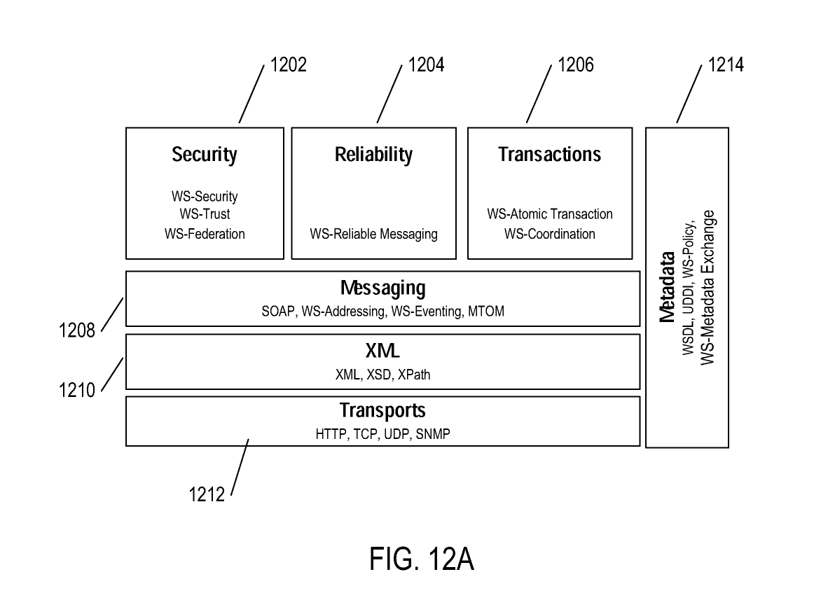

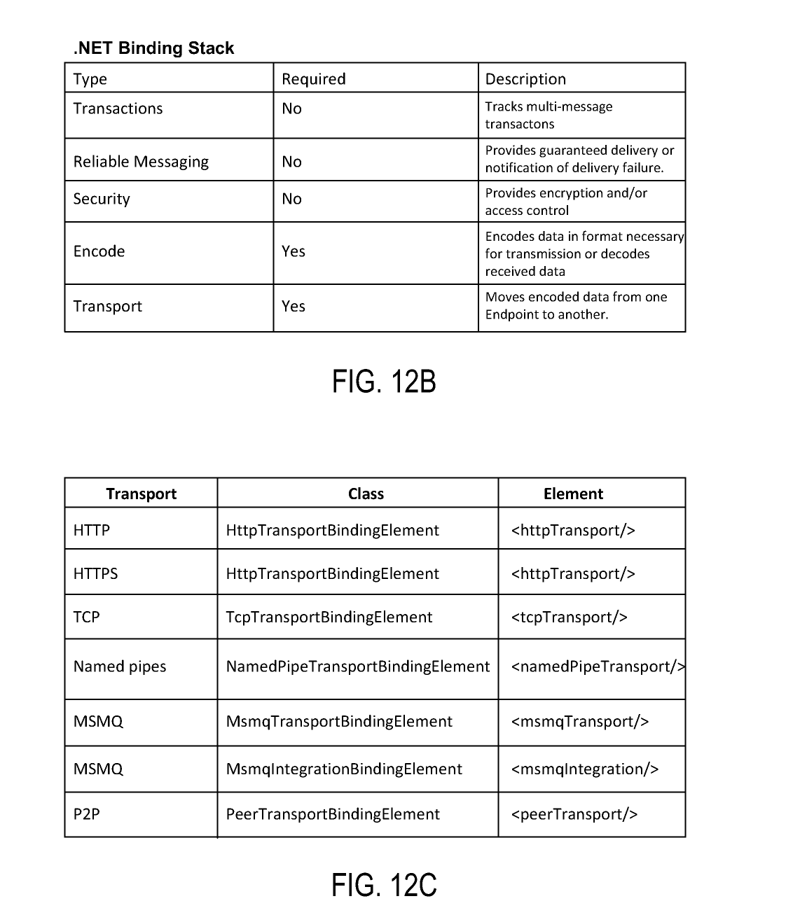

FIG. 12A illustrates, using a somewhat different illustration convention than used in previous figures, the WCF communications stack associated with web services along with the standards supported within the communications stack. The primary networking functionalities carried out by protocol channels and the transport channel within a binding include security 1202, reliability 1204, transaction support 1206, messaging 1208, message formatting 1210, and various types of transport protocols 1212. In addition, the WCF provides for the exchange of metadata 1214 to allow clients of a web service to determine, using only the endpoint address, the information needed for the client to communicate with the web service.

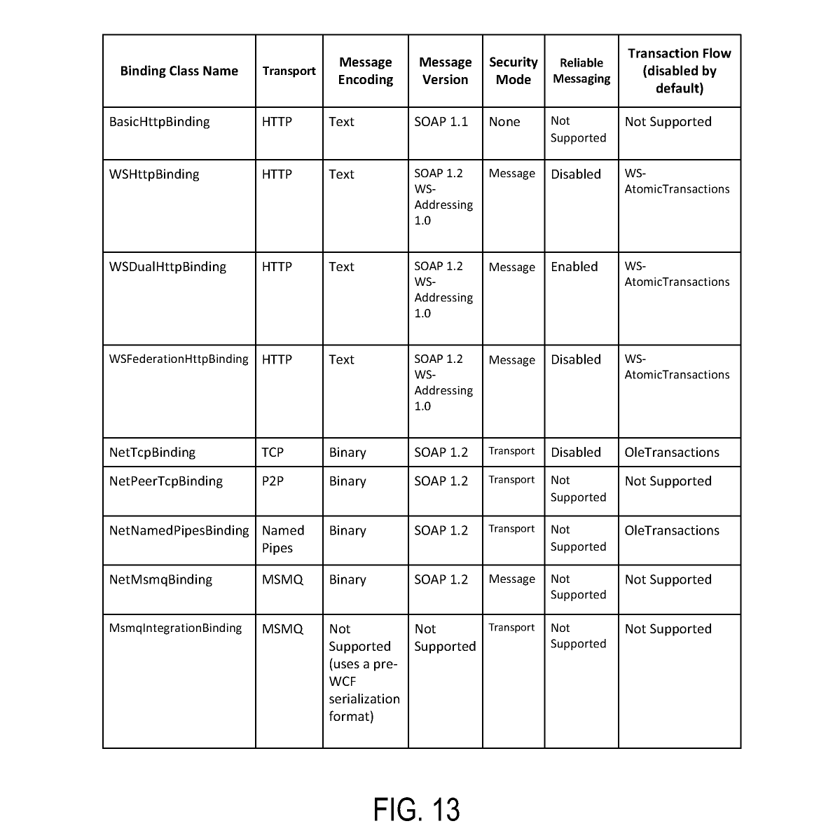

FIGS. 12B-C provide tables that further describe the WCF communications stack. FIG. 12B shows a table that describes the various types of WCF communications-stack channels. FIG. 12C provides a table that lists the various types of transport channels supported by the WCF. FIG. 13 provides a table of the various different standard bindings supported by WCF.

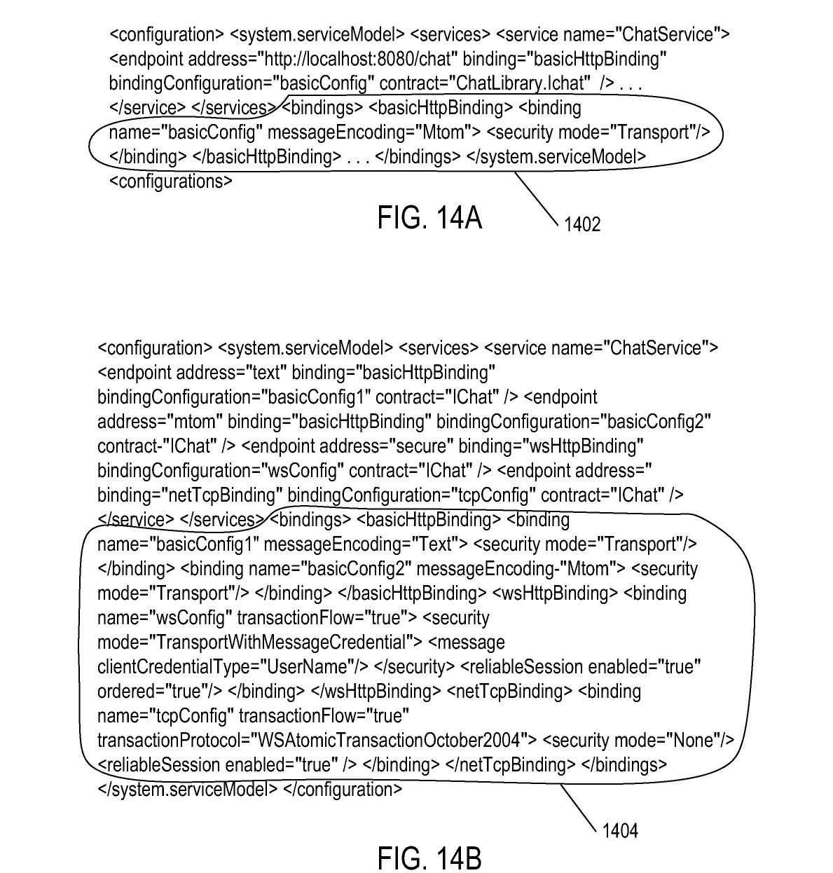

FIGS. 14A-B illustrate XML-based binding configurations. FIG. 14A shows the XML configuration file for an example web service that includes a binding configuration based on the standard basicHttpBinding binding class 1402. FIG. 14B shows an XML configuration file that includes configuration of multiple bindings associated with a particular web service. The multiple bindings occur within the bindings configuration 1404. The two configuration specifications shown in FIGS. 14A-B provide examples of how one or more bindings associated with a web service can be concisely specified in an XML configuration file.

Next, one implementation of an enhanced NIC with offload capability is described. In this implementation, the standard protocol channels used in standard and custom bindings are slightly modified to be configurable to include the above-discussed offload channel. Furthermore, the custom protocol channels corresponding to standard protocol channels include capability for issuing NIC commands by the above-described technique for embedding NIC commands into messages or by alternative techniques, including accessing a kernel offload mechanism.

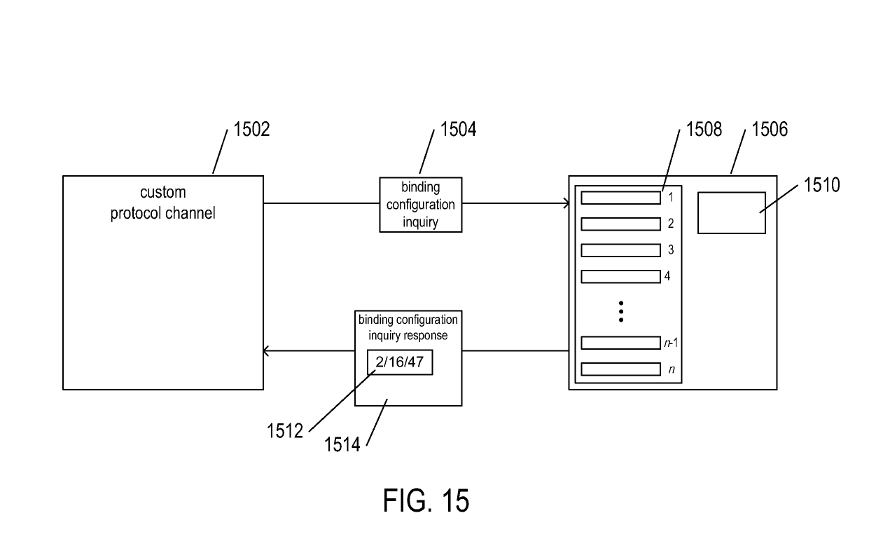

FIG. 15 illustrates use of a binding configuration inquiry NIC command by a custom protocol channel. In FIG. 15, a custom protocol channel 1502 issues a binding configuration inquiry NIC command 1504 to an enhanced NIC 1506. The enhanced NIC includes a set of firmware implementations of standard protocol channels and transport channels 1508 as well as firmware modules 1510 that implement enhanced-NIC functionalities. The binding configuration inquiry command includes command data consisting of a binding configuration for the binding that includes the custom protocol channel. The enhanced NIC compares this binding configuration to the list of firmware-supported protocol channels and transport channels and returns a stack signature 1512 in a binding configuration inquiry response 1514 to the custom protocol channel. The stack signature 1512 lists the identifiers of the protocol channels and transport channel, starting from the transport channel and moving upward in the communications stack, that are supported by the enhanced NIC firmware. In other words, the stack signature provides a mapping of the transport channel and any additional adjacent protocol channels in the binding that can be offloaded to the enhanced NIC. Using the stack signature, the custom protocol channel can configure the communications stack for offload.

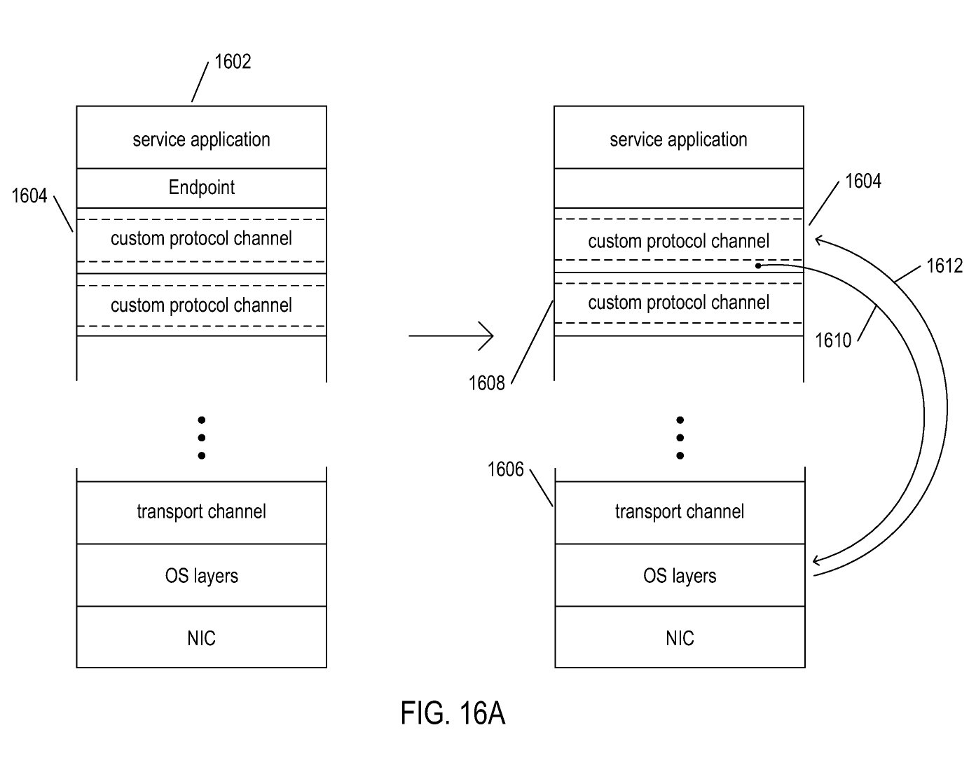

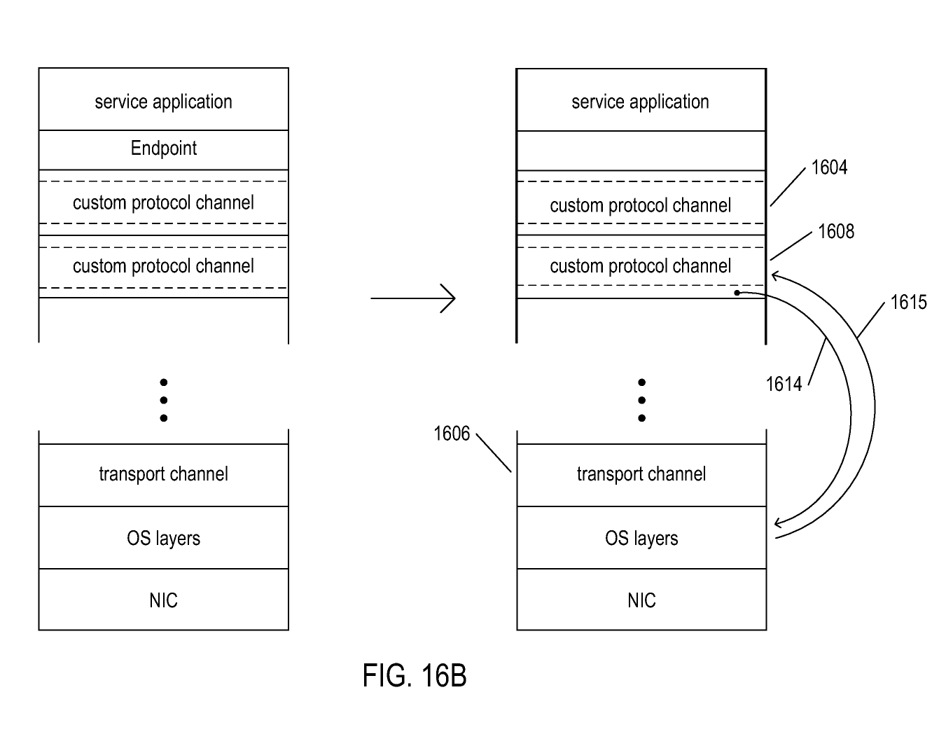

FIGS. 16A-B illustrate examples of communications-stack configuration based on a stack signature returned by an enhanced NIC. Initially, the communications stack 1602 includes custom protocol channels that are slightly modified versions of standard protocol channels specified in the binding associated with the endpoint for a service application. When the service application is launched, and a WCF method is called by the service application to open a listener, the first protocol channel 1604 issues a binding configuration inquiry to the NIC. When the NIC is not an enhanced NIC, and cannot respond to the binding configuration inquiry, the custom protocol channels essentially revert to standard protocol channels and the communications stack operates in a traditional fashion without offload. However, when the NIC is enhanced with offload capabilities, and replies to the binding configuration inquiry with a stack-signature-containing response, the first custom protocol channel configures the communications stack for offload. In FIG. 16A, the returned signature stack indicated that the enhanced NIC firmware supports the transport channel 1606 and all of the protocol channels up through the second protocol channel 1608. Therefore, the first protocol channel 1604 configures itself to transport messages directly to the NIC through a kernel-bypass mechanism and configures the kernel bypass mechanism to transfer incoming requests from the NIC directly to the first protocol channel as represented by curved arrows 1610 and 1612 in FIG. 16A. As shown in FIG. 16B, in the case that the stack signature indicates that the enhanced NIC supports the transport channel 1606 and any higher-level protocol channels above the transport channel but below the second protocol channel 1608, the first protocol channel 1604 configures the first protocol channel and second protocol channel for offload from the second protocol channel, as indicated by curved arrows 1614 and 1616 in FIG. 16B. In this fashion, each binding, upon initial access through the endpoint by the service application, configures itself to offload as many protocol channels and the transport channel as possible based on a binding configuration inquiry response received from the enhanced NIC.

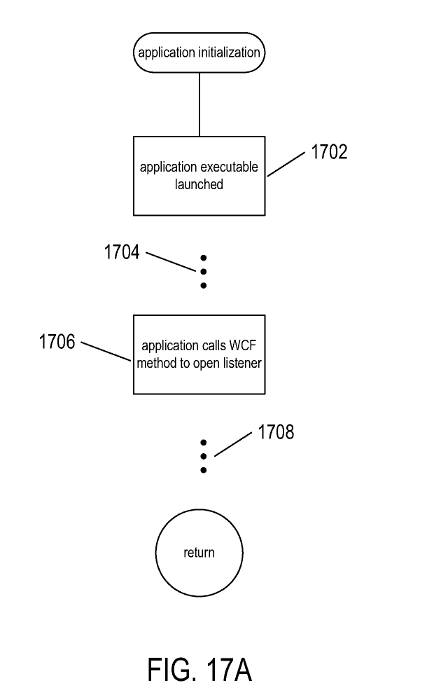

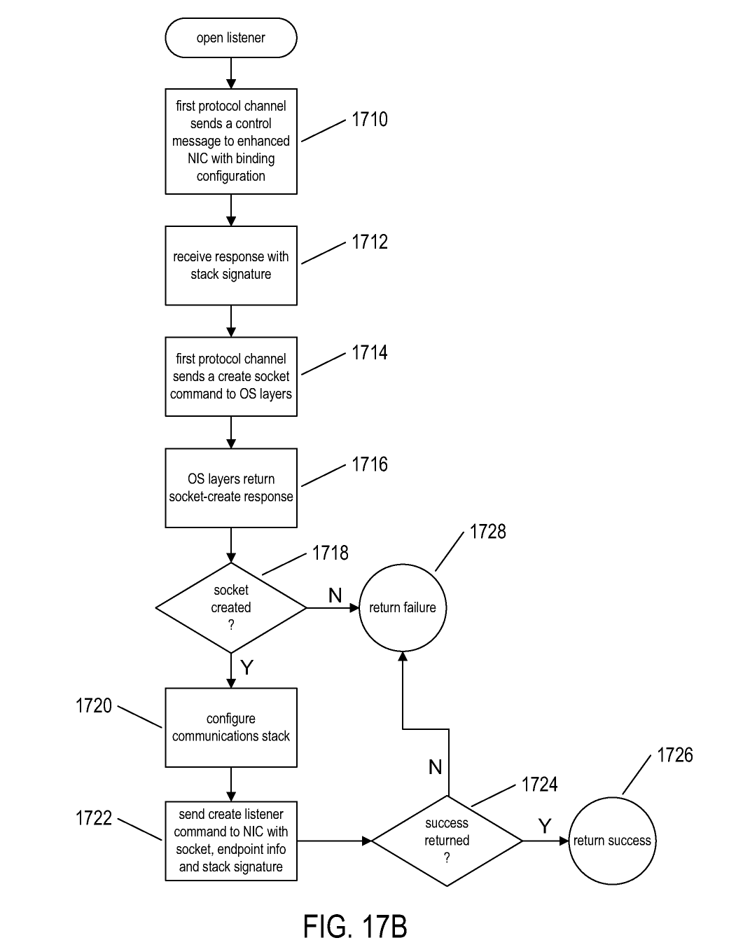

FIGS. 17A-B provide control-flow diagrams that illustrate the implementation of communications-stack offload to an enhanced NIC in the user-mode portion of a server communications stack. In FIG. 17A, a service application is launched, in step 1702 and, after many initialization steps represented by ellipses 1704, calls a WCF method through the endpoint associated with the application service to open a listener for receiving requests from clients in step 1706. Following successful opening of a listener, the service application continues to execute, receiving requests from remote clients and responding to those requests, in a continuous series of operations represented in FIG. 17A by ellipses 1708.

FIG. 17B illustrates the open-listener call made in step 1706 of FIG. 17A. In step 1710, a first protocol channel in the communications stack sends a control message to an enhanced NIC that includes the binding configuration. In step 1712, the first protocol channel receives the response containing a stack signature. In step 1714, the first protocol channel sends a create-socket command to the OS layers of the communications stack which return, in step 1716, a response to the create-socket command. When a socket has been successfully created as determined in step 1718, then the first protocol channel configures the communications stack, in step 1720, according to the returned stack signature, as discussed above with reference to FIGS. 16A-B. Then, in step 1722, the first protocol channel sends a create listener command to the enhanced NIC along with socket and endpoint information and the stack signature. When the enhanced NIC returns an indication of a success, as determined in step 1724, then the open-listener method returns success in step 1726. Otherwise, when either socket creation failed, as determined in step 1718, or the create-listener command failed, as determined in step 1724, the open-listener routine returns failure in step 1728.

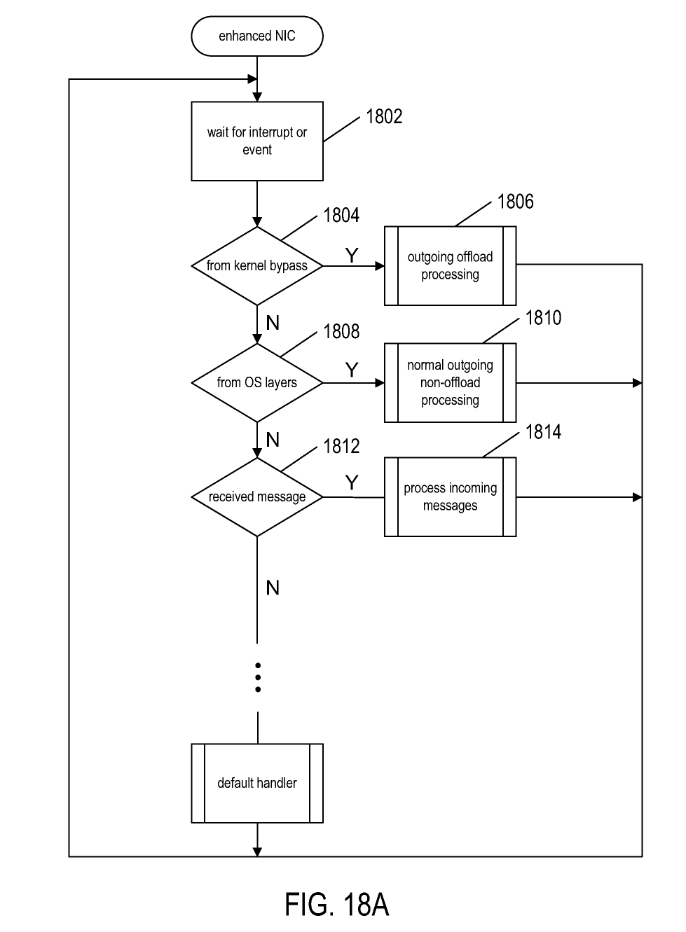

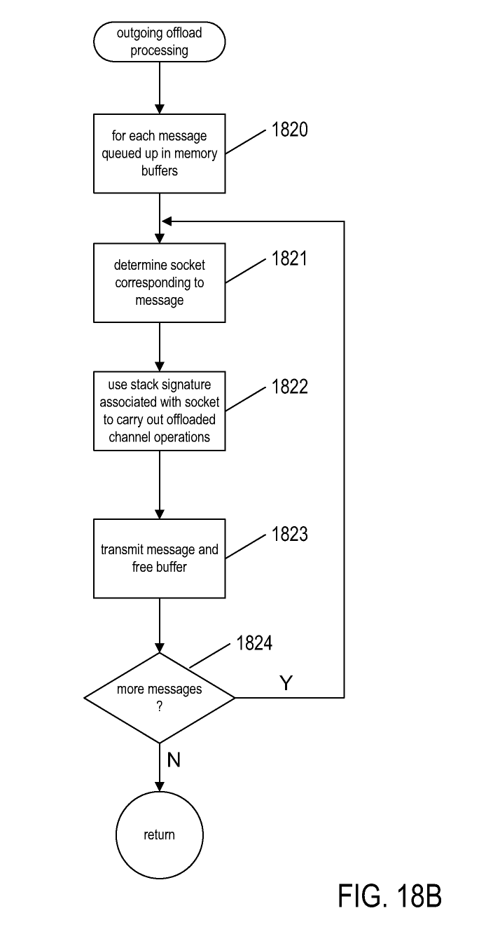

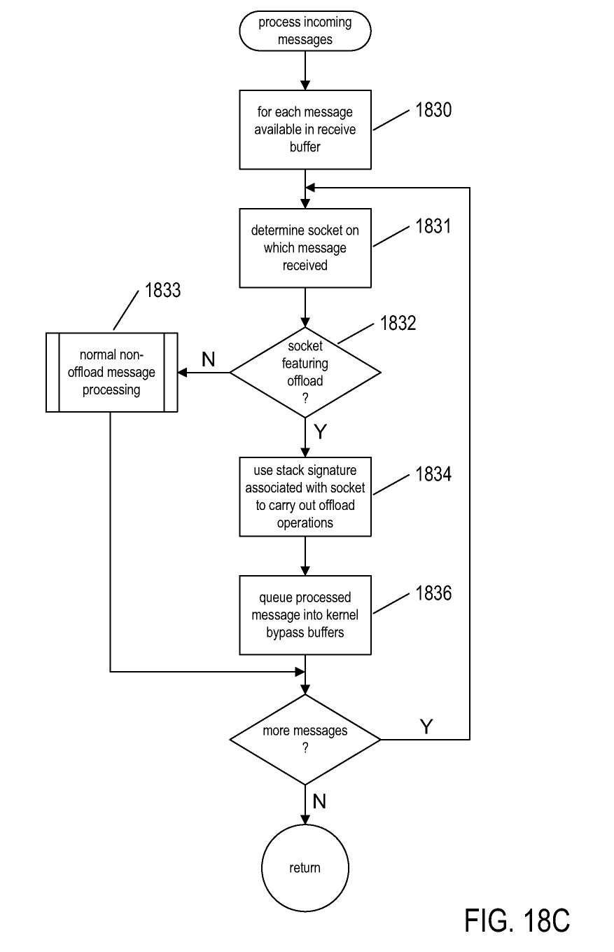

FIGS. 18A-C illustrate operation of an enhanced NIC with offload capability. FIG. 18A shows an underlying event-handling loop within the enhanced NIC. The enhanced NIC waits for a next interrupt or event, in step 1802, and then, in subsequent steps, determines the nature of the event or interrupt and calls a corresponding handler for the event or interrupt. When the event or interrupt is generated by the kernel bypass mechanism to notify the enhanced NIC of an offload message ready for processing and transmission, as determined in step 1804, the handler “outgoing offload processing” is called in step 1806. An interrupt from OS or virtualization layer, detected in step 1808, is handled by calling a normal outgoing non-offload processing routine 1810. When an interrupt has been generated by reception of an incoming message, as determined in step 1812, the handler “process incoming messages” is called in step 1814.

FIG. 18B illustrates the handler “outgoing offload processing” called in step 1806 of FIG. 18A. In the for-loop of steps 1820-1824, each message that is queued up in memory for transmission by the enhanced NIC is processed. To process the next message, the socket corresponding to the message is determined, in step 1821, and, in step 1822, the stack signature associated with the socket is used to determine which offload channel operations to carry out and to carry out those determined offloaded channel operations. After carrying out all of the offloaded channel operations in step 1822, the NIC transmits the message, in step 1823, freeing the shared message buffer for subsequent use.

FIG. 18C provides a control-flow diagram for the handler “process incoming messages” called in step 1814 of FIG. 18A. In the for-loop of steps 1830-1836, each message in a receive buffer within the NIC is processed. To process a next received message, the NIC determines the socket on which the message was received, in step 1831. When the socket is not associated with offloading, as determined in step 1832, then normal non-offload message processing is carried out in step 1833, which involves transferring the received message to lower-level layers of the communications stack executed within the operating system or virtualization layer. Otherwise, if the socket is associated with offload, the stack signature associated with the socket is consulted, in step 1834, in order to determine which offload operations to carry out on the message within the NIC and carry out those determined offload operations. Then, in step 1835, the process message is queued into the shared memory buffers associated with the kernel-bypass mechanism.

Although the present invention has been described in terms of particular embodiments, it is not intended that the invention be limited to these embodiments. Modifications within the spirit of the invention will be apparent to those skilled in the art. For example, any of many different implementations of communications-stack protocol-channel and transport-channel offload to communications devices can be obtained by varying any of many different design and implementation parameters, including programming language, communications stacks, underlying operating system, data structures, control structures, modular organization, NIC interfaces, and other such parameters. The offload can be extended to communications stacks other than WCF communications stacks, as one example. Any of various different offload channel and OS/Kernel bypass implementations may be employed to facilitate relatively direct communications between the communications stack, running in user mode, with an enhanced NIC.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for a method and system for communications-stack offload to a hardware controller.

Accordingly, the present method and/or system may be realized in hardware, software, or a combination of hardware and software. The present method and/or system may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. An offloading network-interface controller within a computer system, the offloading network-interface controller comprising:
one or more processors;
an internal memory; and
firmware instructions stored within the offloading network-interface controller and executed by the one or more processors that includes implementations of one or more user-mode transport and upper-level protocol channels as well as operating-system-mode lower-level protocols of a communications stack, the firmware instructions controlling the offloading network-interface controller to operate in one of
an offload mode, in which case the offloading network-interface controller executes, on one or more of the one or more processors, the operating-system-mode lower-level protocols and at least the user-mode transport protocol channel, and
a non-offload mode, in which case the one or more system processors execute the user-mode transport and upper-level protocol channels as well as operating-system-mode lower-level protocols of the communications stack.

2. The offloading network-interface controller of claim 1 wherein the offloading network-interface controller further comprises:
a first communications interface to a communications medium that interconnects the offloading network-interface controller with one or more system processors and a system memory of the computer system;
a direct-memory-access engine that transfers communications packets from the internal memory to the system memory and from the system memory to the internal memory through the first communications interface;
a second communications interface to a communications medium that interconnects the offloading network-interface controller with remote computers; and
a medium-access-control component that transfers communications packets from the internal memory to remote computers and receives from remote computers into the internal memory through the second communications interface.

3. The offloading network-interface controller of claim 1 wherein the communications stack used in the computer system includes a user-mode endpoint, one or more user-mode upper-level protocol channels, a user-mode transport protocol channel, and operating-system-mode lower-level protocols.

4. The offloading network-interface controller of claim 3 wherein the user-mode endpoint, one or more user-mode upper-level protocol channels, and the user-mode transport protocol channel are elements of a binding associated with the user-mode endpoint, in turn associated with a service application, contract, and endpoint address.

5. The offloading network-interface controller of claim 3 wherein, during processing of an initial request made by a service application to the user-mode endpoint, a first upper-level protocol channel determines a highest user-mode channel of the communications stack that can be offloaded to the offloading network-interface controller and configures the communications stack to offload the highest user-mode channel and user-mode channels below the highest user-mode channel to the offloading network-interface controller.

6. The offloading network-interface controller of claim 5 wherein, when the service application is launched, a socket and listener are established within the offloading network-interface controller.

7. The offloading network-interface controller of claim 5 wherein the first upper-level protocol channel determines the highest user-mode channel of the communications stack that can be offloaded to the offloading network-interface controller by transmitting a binding-configuration inquiry to the offloading network-interface controller and receiving a response from the offloading network-interface controller.

8. The offloading network-interface controller of claim 5 wherein the first upper-level protocol channel configures the communications stack to offload the highest user-mode channel and user-mode channels below the highest user-mode channel by introducing or activating an offload channel within the communications stack above the highest user-mode channel of the communications stack that can be offloaded to the offloading network-interface controller.

9. The offloading network-interface controller of claim 8 wherein the offload channel includes a bypass mechanism for transferring requests and messages from the offload channel directly to the offloading network-interface controller and transferring messages and responses from the offloading network-interface controller to the offload channel.

10. The offloading network-interface controller of claim 8 wherein the first upper-level protocol channel additionally configures a bypass mechanism associated with the communications stack for transferring requests and messages from the offload channel directly to the offloading network-interface controller and transferring messages and responses from the offloading network-interface controller to the offload channel.

11. The offloading network-interface controller of claim 3 wherein the operating-system-mode lower-level protocols include a physical layer and a data-link layer.

12. A method for offload communications processing from one or more system processors of a computer system, the method comprising:
including in the computer system an offloading network-interface controller having one or more processors and an internal memory; and
configuring, by a user-mode protocol channel within a communications stack used within the computer system, the communications stack to offload one or more user-mode channels to the offloading network-interface controller.

13. The method of claim 12 wherein the offloading network-interface controller further includes:
a first communications interface to a communications medium that interconnects the offloading network-interface controller with the one or more system processors and a system memory of the computer system;
a direct-memory-access engine that transfers communications packets from the internal memory to the system memory and from the system memory to the internal memory through the first communications interface;
a second communications interface to a communications medium that interconnects the offloading network-interface controller with remote computer;
a medium-access-control component that transfers communications packets from the internal memory to remote computers and receives from remote computers into the internal memory through the second communications interface; and
firmware instructions stored within the offloading network-interface controller and executed by the one or more processors that includes implementations of one or more user-mode transport and upper-level protocol channels as well as operating-system-mode lower-level protocols of the communications stack, the firmware instructions controlling the offloading network-interface controller to operate in one of
an offload mode, in which case the offloading network-interface controller executes, on one or more of the one or more processors, the operating-system-mode lower-level protocols and at least the user-mode transport protocol channel, and
a non-offload mode, in which case the one or more system processors execute the user-mode transport and upper-level protocol channels as well as operating-system-mode lower-level protocols of the communications stack.

14. The method of claim 12
wherein the communications stack used in the computer system includes a user-mode endpoint, one or more user-mode upper-level protocol channels, a user-mode transport protocol channel, and operating-system-mode lower-level protocols;
wherein the user-mode endpoint, one or more user-mode upper-level protocol channels, and the user-mode transport protocol channel are elements of a binding associated with the user-mode endpoint, in turn associated with a service application, contract, and endpoint address; and
wherein the operating-system-mode lower-level protocols include a physical layer and a data-link layer.

15. The method of claim 14 further comprising, during processing of an initial request made by the service application to the user-mode endpoint:
determining, by a first upper-level protocol channel, a highest user-mode channel of the communications stack that can be offloaded to the offloading network-interface controller; and
configuring, by the first upper-level protocol channel, the communications stack to offload the highest user-mode channel and user-mode channels below the highest user-mode channel to the offloading network-interface controller.

16. The method of claim 15 wherein, when the service application is launched, a socket and listener are established within the offloading network-interface controller.

17. The method of claim 15 wherein the first upper-level protocol channel determines the highest user-mode channel of the communications stack that can be offloaded to the offloading network-interface controller by:
transmitting a binding-configuration inquiry to the offloading network-interface controller and receiving a response from the offloading network-interface controller.

18. The method of claim 15 wherein the first upper-level protocol channel configures the communications stack to offload the highest user-mode channel and user-mode channels below the highest user-mode channel by:
introducing or activating an offload channel within the communications stack above the highest user-mode channel of the communications stack that can be offloaded to the offloading network-interface controller.

19. The method of claim 18 wherein the offload channel includes a bypass mechanism for transferring requests and messages from the offload channel directly to the offloading network-interface controller and transferring messages and responses from the offloading network-interface controller to the offload channel.

20. The method of claim 18 wherein the first upper-level protocol channel additionally configures a bypass mechanism associated with the communications stack for transferring requests and messages from the offload channel directly to the offloading network-interface controller and transferring messages and responses from the offloading network-interface controller to the offload channel.
